(19) United States
(12) Patent Application Publication
(10) Pub. No.: US 2025/0136332 A1
(43) Pub. Date: May 1, 2025

(54) CHILD RESISTANT CAP

(71) Applicant: Terry Vovan, Riverside, CA (US)

(72) Inventor: Terry Vovan, Riverside, CA (US)

(21) Appl. No.: 18/494,518

(22) Filed: Oct. 25, 2023

(51) Int. Cl. B65D 50/04; A61J 1/14; B65D 41/04; B65D 51/30

(52) U.S. Cl. CPC B65D 50/041; A61J 1/1418; B65D 41/0442; B65D 41/0492; B65D 51/30; B65D 2203/00; B65D 2215/02; B65D 2251/205

(57) ABSTRACT

A child-resistant cap assembly that is adapted to attach to the various shapes of the containers has an outer lid, an activate button body, an inner lid, and an optional desiccant basket for packaging container applications. The outer lid is adapted to receive and engage the rigid fingers when the activate button body assembly is depressed. The inner lid has latched grooves that position the rigid fingers. The rigid fingers are connected to a button with a flexible pivotable hinge and are radially moved upwards and/or outwards by a shaped protrusion or a ramp to engage circumferentially spaced grooves, allowing the cap assembly to be rotated counter-clockwise to disengage from the container. Clockwise rotation locks the cap assembly onto the container; otherwise, it functions as a child-safety feature.

### I. BACKGROUND OF THE INVENTION

### 1. Field of the Invention

The present invention relates to the field of child-resistant caps for consumer packaging containers, including cosmetic and pharmaceutical bottles or containers that are unique and improved from the traditional child-resistant safety containers. Particularly safety containers being used by elderly persons and those that have been afflicted with rheumatoid arthritis. The current invention comprises three separate components that comprise an outer lid, an activate button, and an inner lid that has fastening features that allows the child-resistant cap to screw onto the pharmaceutical container and overcomes the problem of children being able to open the cap but isn't too difficult to open for the elderly and those afflicted with rheumatoid arthritis.

### 2. Description of the Prior Art

U.S. Pat. No. 3,181,718 by Chancellor discloses a bottle stopper that uses a cap with a button that releases pins that are co-incident with recesses on a bottle. When depressed, the pins retract and allow the cap to be rotated. When stationary, the pins engage the recesses in the bottle, preventing the cap from rotating. This patent differs from the Applicant's invention in several ways. One is that the Applicant's invention is self-contained and doesn't require a bottle to stop the rotation of the cap.

U.S. Pat. No. 6,986,807 by Brunk describes a Desiccant Bottle Cap. This patent describes that a desiccant packet is attached to an inner surface of the cap, or adhered to a surface of a desiccant liner. Applicant's invention uses a basket that is fixed to the inner lid of the cap assembly. The basket contains the desiccant package away from any material in the bottle. The desiccant basket has a cross-hatched mesh that prevents any material in the bottle from contacting the desiccant package, but captures the desiccant package.

U.S. Pat. No. 3,735,887 by Morris discloses a Safety Cap for Medicine Containers. This patent discloses that “the container neck is formed with external screw-threads near its open end and a plurality of circumferentially equidistantly spaced locking lugs or projections is formed on the interior of the neck near and below its open end and projecting radially into the bore or outlet passage of the neck.”

In effect, U.S. Pat. No. 3,735,887 requires that the medicine container be modified to use the Morris patented invention. Without the modification to the container by the manufacturer, the Morris patent is not useable. This is quite different than the Applicant's invention as the Applicant uses an outer lid an activate button and an inner lid where when the activate button is depressed it engages recesses within the outer lid to allow the cap to disengage from the medicine bottle.

### 3. SUMMARY OF THE INVENTION

With the proliferation of the use of medications in the current age, there is a recognized need for a simple, reliable, and reasonably economical safety cap for medicine and other containers, including such common household medicines as aspirin tablets, blood pressure pills, and tranquilizers. As the use of such drugs by adults continues to increase, it is more and more vital to protect young children from easily opening dangerous medicine containers. While this need has been recognized for some time and certain proposals to satisfy the need have been made in the prior art, the need has become much more urgent recently.

Many safety caps on the market are being designed and used for pharmaceutical packaging containers to prevent young children from opening the medicine containers, but they are limited to either using a plastic shrink-band or pressing down hard on the cap to resolve or provide the child safety feature. However, the existing child safety caps on the market present a problem for older people and patients with rheumatoid arthritis (RA) or Parkinson's disease (PD) to open the medicine containers by pressing hard on the cap and rotating simultaneously or using a sharp tool to cut out the plastic shrink-band.

With the above realities in mind, the objective of this invention is to provide a practical, reliable, and economical child-resistant safety cap that will be sufficiently difficult to remove from the medicine container to confuse young children so that they will stop attempting to open the containers and being deterred from unintentional harm. Simultaneously, the container closure will be sufficiently simple to operate by adults and infirm persons so as not to seriously impede access to the medication in the container in the event of an urgent need for such medication. Additionally, the cap assembly has a desiccant basket that contains the desiccant and is separated from the medication to prolong the shelf life of the medication. The desiccant protects the medication from moisture and the desiccant basket prevents the elderly or patients from unintentionally swallowing the desiccant package.

Basically, the packaging containers are portable and convenient to use; their design consist of a container and lid or cap that contain various products from solids, and gels to liquid materials. These typical packaging containers are made of plastic, glass, metal, composites, or combinations of these materials or the like. These packaging containers are used in cosmetics, personal care, consumer or industrial products, and pharmaceutical industries where the final products are important to the end users. The child-resistant safety cap lid embodying the invention comprises a screw-type fastening of a three-piece cap for engagement over the exterior screw-type on the neck or outlet of the standard medicine container for closing and tightening the lid by turning it clockwise, while having an outer lid that can engage fingers from an axially activated activate button when the activate button has been depressed. The activate button has a flexible portion that permits the fingers to move outwardly and/or upwardly, engaging cavities in the outer lid and when rotated counterclockwise allows the cap to rotatably disengage from the medicine container. When at rest or the activate button hasn't been depressed, the activate button does not engage, and the fingers are disengaged from the circumferentially spaced grooves of the outer lid, allowing the outer lid to rotate counterclockwise freely or indexing without holding the activate button, which disengages the inner lid from unfastening from the container.

The child-resistant cap also possesses several additional features such as a double-seals feature to prevent the transmission of the elements into the container while the desiccant basket is attachable below the child safety cap to prolong the shelf-life of products or medicines. These advantages clearly over the prior art which will become apparent during the following detailed description.

Other aspects and advantages of the invention will be apparent from the description and claims that follow.

### II. BRIEF DESCRIPTION OF THE DRAWINGS

FIG. 1. Shows a view of different containers with the child-resistant cap assembly;

FIG. 2. Shows an exploded view of the child-resistant cap assembly and a representative container;

FIG. 3. Shows a reverse exploded view of the child-resistant cap assembly and a representative container;

FIG. 4. Shows a view with the outer lid in partial cross section showing the inner lid and activate button body;

FIG. 5. Shows a full cross section of the child-resistant cap assembly and a container;

FIG. 6. Shows a view with the outer lid in partial cross section showing the inner lid and activate button body and the latches in the engagement position;

FIG. 7. Shows a full cross section of the child-resistant cap assembly and a container with the latches in the engagement position;

FIG. 8. Shows a full cross section of the child-resistant cap assembly and a container with the latches in an unengaged position with a ramp;

FIG. 9. Shows a full cross section of the child-resistant cap assembly and a container with the latches in an engaged position with a ramp;

FIG. 10. Shows a partial cross section of the outer lid showing the latch in a latch slot of the inner lid.

FIG. 11. Shows a partial cross section of the outer lid showing the latch in a latch slot of the inner lid the latch tip being shaped;

FIG. 12. Shows a top view of a partial cross section of the outer lid showing the latch in a latch slot of the inner lid showing the shaped latch tip.

### III. DETAILED DESCRIPTION OF THE PREFERRED EMBODIMENTS

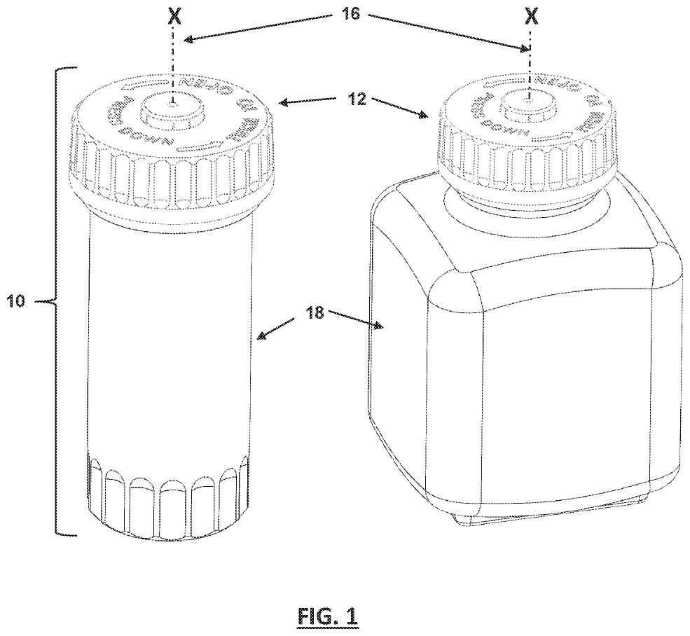

FIG. 1 shows medicine container assemblies (10) that uses a child-resistant cap assembly (12) which for the current invention fastening method engages the male fasteners (14) that are typical for standard medicine containers (18). The cap assembly (12) has an x-axis (16) about which the cap assembly (12) can rotate.

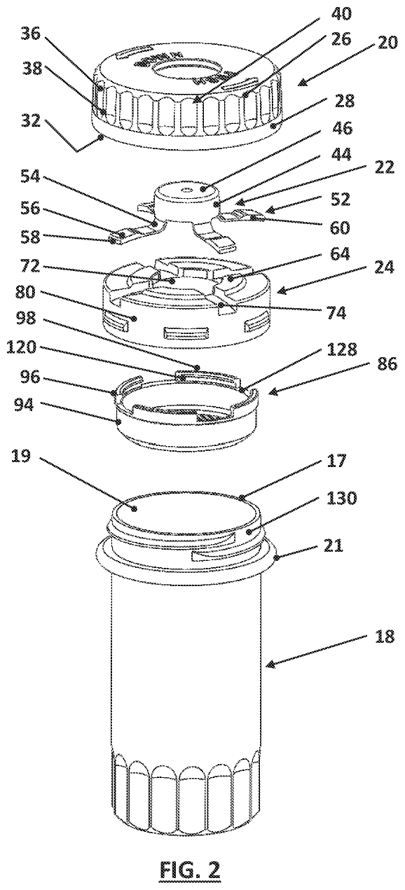

With respect to FIG. 2 showing an exploded view of a child-resistant lid container (12). The child-resistant cap assembly (12) comprises an outer lid (20), an activate button body (22) and an inner lid (24).

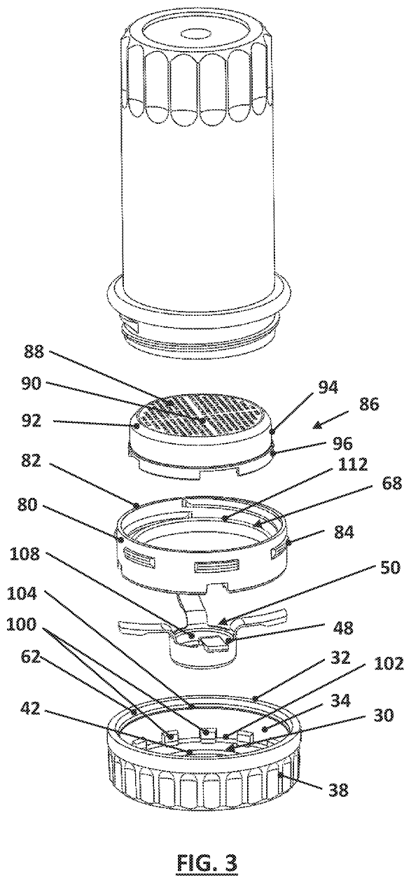

The outer lid (20) has a top surface (26) and a vertical wall (28) extending downwards from the top surface (26) of the outer lid (20) creating an internal cavity (30) for the outer lid (20) and a first bottom edge (32). The vertical wall (28) of the outer lid (20) further has an inner surface (34). The vertical wall (28) has a grip surface (36), where the grip surface may have (32) ridges (38) that assist in gripping the outer lid (20). Located on the top surface (26) of the outer lid (20) is a centrally located through hole (40) that allows the activate button body (22) to protrude through the centrally located hole (40). The internal cavity (30) has a first bottom surface (42) FIG. 3 defined therein, where the first bottom surface (42) opposes the top surface (26) of the outer lid (20). The first bottom edge (32) of the vertical wall (28) of the outer lid (20) has a leading angle (62) that assists in aligning and capturing the inner lid (24) when the inner lid (24) is installed. The cap assembly (12) has an x-axis (16) [FIG. 1] defined that allows the cap assembly (12) to rotate counterclockwise to be removed from the medicine container (18). The top surface (26) may have markings that have been engraved, formed, or molded thereon.

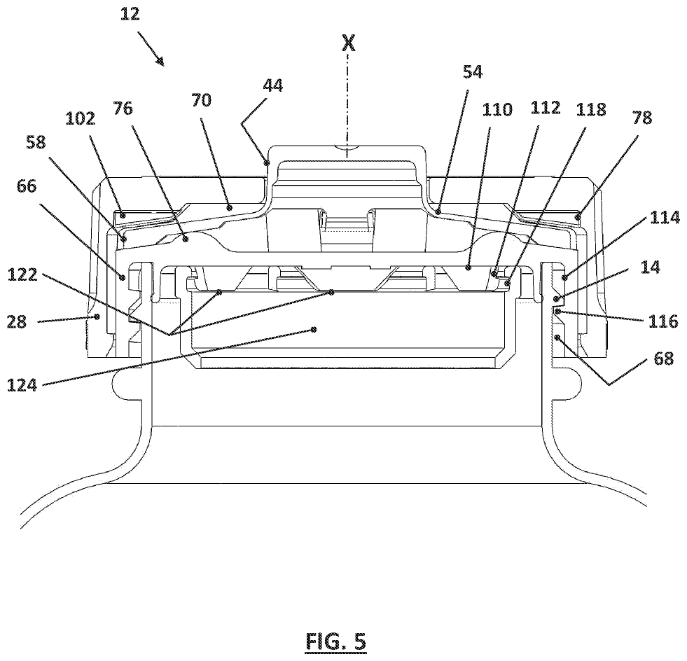

The activate button body (22) has a circular button (44) defined thereon where the circular button (44) extends downward defining an upper surface (46) for a user to press upon moving the circular button (44) along the x-axis (16) and a lower edge (48) and may have a hollow cavity (50) defined therein. The circular button (44) has at least one latch (52) attached to the lower edge (48) [FIG. 3] of the activate button body (22) where the latch (52) is flexibly mounted to the activate button body (22) and the circular button (44) with a flexible pivotal hinge (54). The latch (52) extends outward from the x-axis (16). The activate button body's (22) upper surface (46) allows a user to press down upon and linearly move the circular button (44) along the x-axis (16). The latch further has rigid fingers (56) that connect to the flexible pivotal hinge (54) where the rigid fingers (56) extend further outward. The rigid fingers (56) are stiff and do not flex at the further end of a tip (58) where the tip may have a thicker portion (60) to prevent flexure of the tip (58) of the rigid fingers (56). The shape of the tip (58) of the rigid may be straight or arced to match the spaced groove (102) of the vertical wall (28) of the outer lid (20). Pressing down on the circular button (44) along the x-axis (16) causes the latch (52) to move linearly along the latch slot (74) of the inner lid, forcing the tip (58) to be raised by the shaped protrusion (76) [FIG. 5] to be engaged in opposing walls (26) of the circumferentially spaced grooves (102) of the outer lid (20). The circumferentially spaced grooves (102) of the inner lid (20) prevent flexure of the rigid fingers (56) when engaging the circumferentially spaced grooves (102) of the outer lid (20).

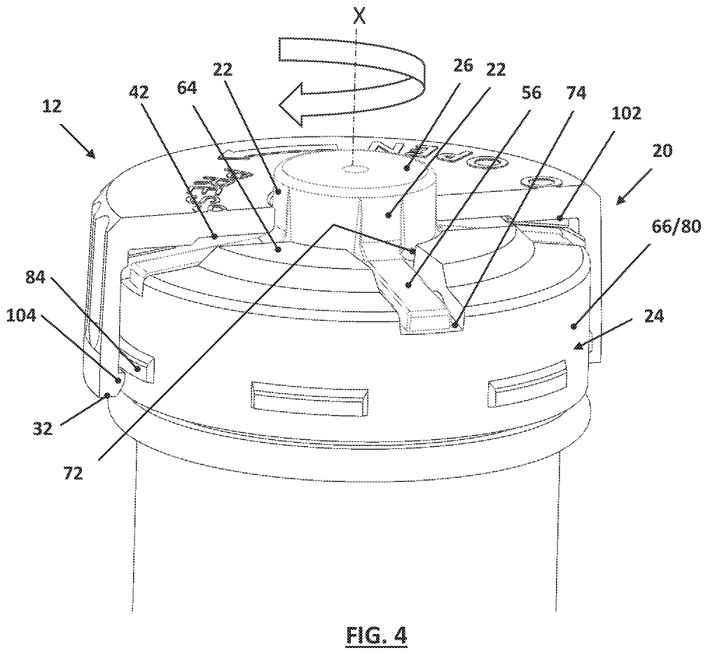

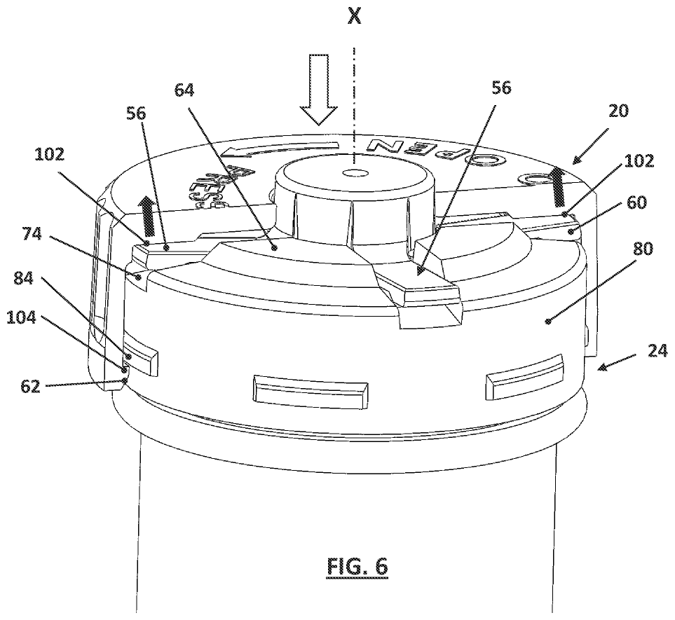

The inner lid (24) has a top surface (64) extending outward to interface with the first bottom surface (42) [FIG. 4] of the outer lid when assembled, where the contacted surface inclines downward, and walls (66) extending downward, where the downward extending walls (66) [FIG. 5] create an internal cavity (68) thereby. The top surface (64) has a thickness (70), where the thickness (70) allows for a centrally located cavity (72) for the activate button body (22) to reside when pressed and has at least one latch slot (74) where the latch slot (74) allows the rigid finger(s) (56) to slideably fit therein. The latch slot (74) in the inner lid (24) has a latch bottom wall (142), and opposing walls (144) [FIG. 6] which have a shaped protrusion (76) defined thereon, where the shaped protrusion (76) can be arc shaped or triangular shaped to a point that forces the tip (58) of the rigid finger (56) to be driven upwards or outwards toward a second bottom surface (78) or the inner surface (34) of the outer lid (20). The wall (66) of the inner lid (24) has an exterior surface (80) and a bottom edge (82). Biased towards the bottom edge (82) of the exterior surface (80) of the wall (66) of the inner lid (24) are circumferentially spaced retaining protrusions (84).

A desiccant basket (86) is shown where a fine mesh (88) on the base surface (90) is shown having an outer edge (92). The outer edge (92) of the base surface (90) has a vertical surface (94) extending upward and having an upper edge (96) shown. A circumferential ring (98) is shown, which allows the desiccant basket (86) to be attached to the inner lid (24). The circumferential ring (98) of the desiccant basket (86) may be continuous around the upper edge (96) of the vertical surface (94) or may be fabricated as equally spaced circumferential segments (128) around the upper edge (96) of the vertical surface (94) of the desiccant basket (86). The circumferential ring (98) has a snap-on groove (120) defined thereon. The snap-on groove (120) is circumferentially defined around the upper edge (96) and provides a locking feature for the desiccant basket (86). The fine mesh (88) base surface (90) allows any moisture within the sealed medicine container assembly (10) to be captured by a desiccant package (not shown). Other attachment mechanisms between the desiccant basket and the inner lid can be installed by a snap-on or a fastening feature at the center X axis (not shown)

With respect to FIG. 3, we see the components of the invention showing an inverted view. The outer lid (20) is shown with the internal cavity (30) visible. The first bottom surface (42) and internal cavity (30) are shown to have a raised portion (100) where the raised portion (100) allows for circumferentially spaced grooves (102) to be defined therein, the circumferentially spaced grooves (102) are placed adjacent to the vertical wall (28) of the outer lid (20). The circumferentially spaced grooves (102) are wide enough to grip the rigid fingers (56) when the rigid fingers (56) are engaged therein by action of the activate button body (22) downward to the centrally located cavity (72). Biased towards the bottom edge (32) of the vertical wall (28) is a flexible retaining ring (104). The flexible retaining ring (104) [FIG. 6] may be continuous or segmented and prevents the inner lid (24) from separating from the outer lid (20) when the circumferentially spaced retaining protrusions (84) are engaged thereby. The flexible retaining ring (104) extends inwards towards the internal cavity (30).

The activate button body (22) is shown here prominently, showing the circular button (44) and the cavity (108) defined therein. The latches (52) are prominently displayed here attached to the lower edge (48) of the activate button body (22). The flexible pivotable hinge (54) is shown with the rigid fingers (56) and the end tip (58). While the activate button body (22) has at least one (1) rigid finger (56), the embodiment and figures show four (4) rigid fingers (56) but more rigid fingers (56) can be used.

The inner lid (24) here prominently shows the downward extending wall (66) and the internal cavity (68). A lower surface (110) of the internal cavity (68), the lower surface (110) being essentially flat, is shown where the lower surface (110) has bosses (112) extending upwards to provide means to align the desiccant basket (86) to be attached thereon. The bosses (112) may have snap-on fingers (118). The snap-on fingers (118) extend upwards and have a protruding boss (122), where the protruding boss (122) creates a cavity (124) between the lower surface (110) of the inner lid (24) and the snap-on fingers (118). The desiccant basket (86) can also be fastened or glued in place to secure the desiccant package therein. The internal cavity (68) of the inner lid has an inner surface (114) defined therein. The inner surface (114) of the internal cavity (68) has a fastener feature formed thereon where the female fastener (116) is designed to coupling with the male fastener (14) of the medicine bottle (18). Defined between the inner surface (114) of the internal cavity (68) and the lower surface (110) of the lower lid (24) is a circular sealing ring (126) where the circular sealing ring (126) is placed at the intersection of the lower surface (110) and the downward extending wall (66) of the inner lid (24). The circular sealing ring (126) [FIG. 6] mates with the inside wall (19) below the rim (17) of the medicine container (18), which creates a first sealing point, while the rim (17) is also pressed against the lower surface (110) that creates a second sealing point when the fastener system is coupling together. The neck ring (21) is located on the outer surface (130) below the male fastener of the container to prevent prying and separating the cap assembly (12). The opposing outer surface (130) is a circular inside surface (19) of the container (18). Pressing down on the upper surface (46) of the circular button (44) along the x-axis (16) causes the latch (52) to move linearly along the latch slot (74) of the inner lid, forcing the tip (58) to be raised by the shaped protrusion (76) to be engaged in the circumferentially spaced grooves (102) of the inner lid (20).

In order to allow free rotation between the inner lid (24) and the outer lid (20) of the cap assembly (12), a small clearance is required between the circumferentially spaced protrusions (84) and the flexible retaining ring (104) while the top surface (64) of the inner lid is facing the first bottom surface (42) of the outer lid. The inner surface (34) of the vertical wall (24) of the outer lid (20) also has a gap (136) defined therebetween.

FIG. 4 shows a partial cross section of the cap assembly (12) with the outer lid (20) of the cap assembly (12) being partially sectioned and the activate button body (22) at rest. The cross section of the outer lid (20) with the activate button body (22) penetrating the top surface (26) of the outer lid (20) through the through hole (40) of the outer lid (20). The exterior surface (80) of the inner lid (24) shows the circumferentially spaced retaining protrusions (84) and the flexible retaining ring (104) where the flexible retaining ring (104) of the first bottom edge (32) of the outer lid (20) [FIG. 6] captures and retains the circumferentially spaced retaining protrusion (84) of the inner lid (24) and allows the inner lid (24) and outer lid (20) to rotate freely and be indexed by the circumferentially spaced grooves (102) of the outer lid (20). Here the rigid fingers (56) are shown resting in a latch slot (74) of the top surface (64) of the inner lid (24). Also shown is the activate button body (22) resting in the centrally located cavity (72) of the inner lid (24).

FIG. 5 is a full cross-section of the medicine container assembly (10) showing the components of the child-resistant cap assembly (12). The outer lid (20) shows the vertical walls (28) creating the internal cavity (30), which permits the activate button body (22) to fit therein. The flexible retaining ring (104) of the vertical walls (28) is prominently shown. Also prominently shown is the medicine bottle (18) with the male fasteners (14) that show engagement with the female fastener (116) formed on the inner surface (114) of the inner lid (24). The flexible pivotable hinge (54) is shown attaching the rigid fingers (56) to the circular button (44) and resting on the shaped protrusion (76) positioned on the latch slot (74) of the lower inner (24). The desiccant basket (86) is shown positioned in the cavity of the inner lid (24).

FIG. 6 shows a partial cross-section of the cap assembly (12) with the activate button body (22) depressed. The cross section of the outer lid (20) with the activate button body (22) penetrating the top surface (26) of the outer lid (20) through the through hole (40) of the outer lid (20). The exterior surface (80) of the inner lid (24) shows the circumferentially spaced retaining protrusions (84) and the flexible retaining ring (104) where the flexible retaining ring (104) of the first bottom edge (32) of the outer lid (20) captures and retains the circumferentially spaced retaining protrusion (84) of the inner lid (24) and allows the inner lid (24) and outer lid (20) to rotate. Here the rigid fingers (56) are shown pivoted about the shaped protrusion (76) in the latch slot (74) of the top surface (64) of the inner lid (24). Also shown is the activate button body (22) resting in the centrally located cavity (72) of the inner lid (24). The rigid fingers (56) have been extended upwards to engage the circumferentially spaced grooves (102) allowing the rotation of the outer lid (20) to engage the rigid fingers (56) of the activate button body (22) to bear against the latch slots (74) in the top surface (64) and internal cavity (30) of the inner lid (24) permitting the inner lid (24) to rotate together and unfasten from the standard medicine container (18).

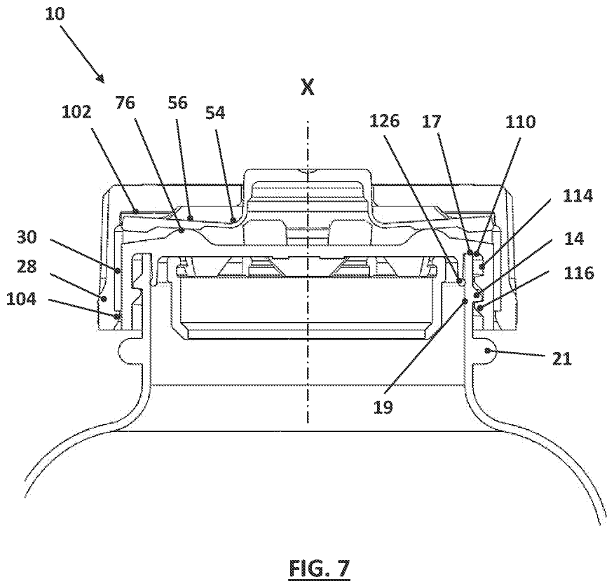

FIG. 7 is a full cross-section of the medicine container assembly (10) showing the components of the child-resistant cap assembly (12). The outer lid (20) shows the vertical walls (28) creating the internal cavity (30) which permits the activate button body (22) to fit therein. The flexible retaining ring (104) of the vertical walls (28) is prominently shown. Also prominently shown is the medicine bottle (18) with the male fastener (14) that shows engagement with the female fastener (116) formed on the inner surface (114) of the inner lid (24). The flexible pivotable hinge (54) is shown attaching the rigid fingers (56) to the circular button (44) and resting on the shaped protrusion (76) positioned on the latch slot (74) of the lower lid (24). The desiccant basket (86) is shown with the inner lid (24). Here the rigid fingers (56) are shown pivoted about the shaped protrusion (76) in the latch slot (74) of the top surface (64) of the inner lid (24). Also shown is the activate button body (22) resting in the centrally located cavity (72) of the inner lid (24). The rigid fingers (56) have been extended upwards to engage the circumferentially spaced grooves (102) allowing the rotation of the outer lid (20) to engage the rigid fingers (56) of the activate button body (22) to bear against the latch slots (74) in the top surface (64) of the inner lid (24) permitting the inner lid (24) to unfasten from the standard medicine container (18).

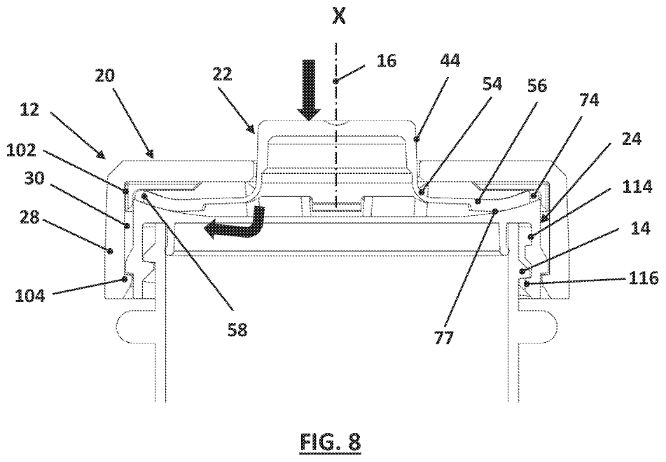

FIG. 8 is a full cross-section of the medicine container assembly (10) showing the components of the child-resistant cap assembly (12). The outer lid (20) shows the vertical walls (28) creating the internal cavity (30) which permits the activate button body (22) to fit therein. The flexible retaining ring (104) of the vertical walls (28) is prominently shown. Also prominently shown is the medicine bottle (18) with the male fasteners (14) that show engagement with the female fastener (116) formed on the inner surface (114) of the inner lid (24). The flexible pivotable hinge (54) is shown attaching the rigid fingers (56) to the circular button (44) and resting on the outward ramp (77) positioned in on the latch slot (74) of the lower lid (24) wherein the tip (58) to be engaged into the spaced grooves (102).

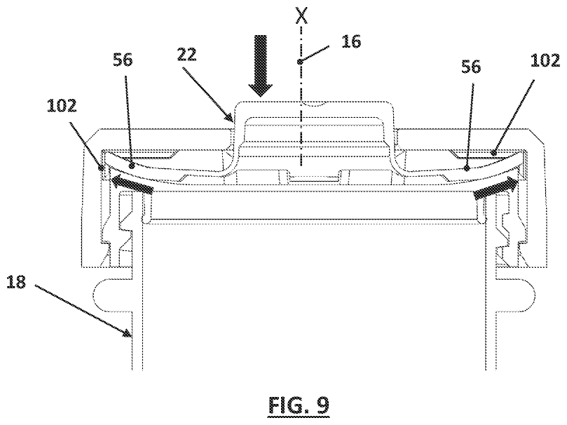

FIG. 9 is a full cross-section of the medicine container assembly (10) showing the components of the child-resistant cap assembly (12). The outer lid (20) shows the vertical walls (28) creating the internal cavity (30) which permits the activate button body (22) to fit therein. The flexible retaining ring (104) of the vertical walls (28) is prominently shown. Also prominently shown is the medicine bottle (18) with the male fasteners (14) that show engagement with the screw fasteners (116) formed on the inner surface (114) of the inner lid (24). The flexible pivotable hinge (54) is shown attaching the rigid fingers (56) to the circular button (44) and resting on the outward ramp (77), positioned in the latch slot (74) of the lower lid (24). When the activate button (22) is depressed, the rigid fingers (56) are shown extended outward and/or upward along the outward ramp (77) and are extended through the latch slot (74) located in the top surface (64) of the inner lid (24). The rigid fingers (56) are extended into the circumferentially spaced grooves (102) of the outer lid (20) and are engaged thereby. Also shown is the activate button body (22) resting in the centrally located cavity (72) of the inner lid (24). The rigid fingers (56) have been extended upwards to engage the circumferentially spaced grooves (102) allowing the rotation of the outer lid (20) to engage the rigid fingers (56) of the activate button body (22) to bear against the latch slots (74) in the top surface (64) and internal cavity (30) of the inner lid (24) permitting the inner lid (24) to unfasten from the standard medicine container (18).

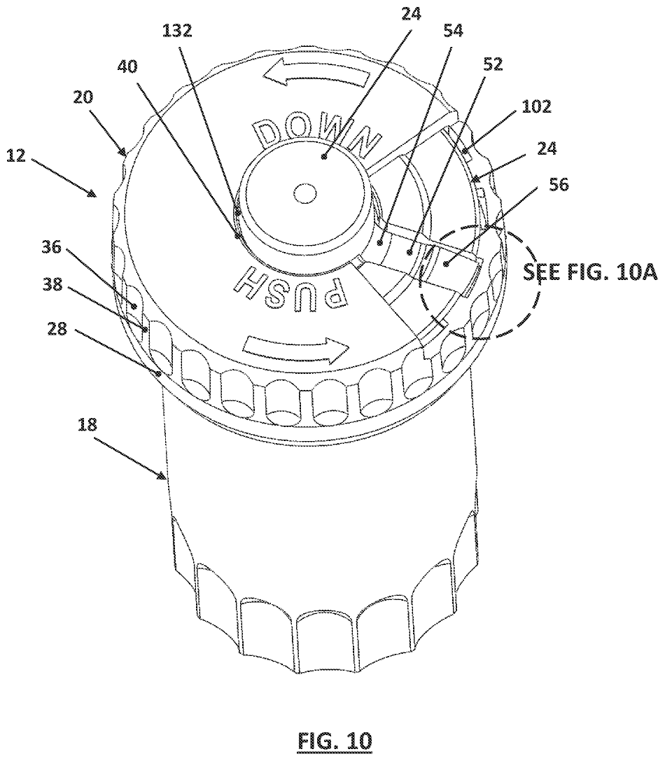

With respect to FIG. 10, the applicant shows the child-resistant cap assembly (12) with a partial cross section of the outer lid (20). The activate button body (22) is shown placed within the centrally located through hole (40) in the outer lid (20). The gap (132) between the circular button (44) and the centrally located through hole (40) allows for easy movement of the activate button body (24). The activate button body (24) is shown with the connecting pivotal hinge (54) attached to the latch (52) which has rigid fingers (56). The vertical walls (28) show the grip surface (36) and the ridges (38) fixed thereon. The tip (58) of the rigid finger (56) is shown with a shape that can be either straight or arced.

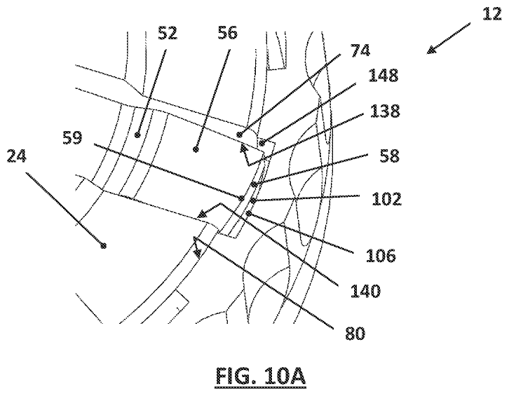

FIG. 11 shows a close-up of the tip (58) of the rigid finger (56) of the latch (52). The closeup shows the inner lid (24) and at least one of the latch slots (74) formed in the inner lid (24) that guides the rigid finger (56) with the curved tip (59) into the circumferentially spaced grooves (102). The latch has a long edge (138) is partially extended into the circumferentially spaced grooves (102), and a short edge (140) is slightly recessed below the exterior surface (80) of the inner lid, wherein the outer lid (20) can be rotated counterclockwise freely about the X axis as a child-safety feature. However, when the outer lid (20) rotates clockwise about the center X axis, the long edge (138) presses against the sidewall (148) of the circumferentially spaced grooves (102) that allows the cap assembly (12) to fasten and tighten to the container (18). When the activate button body (22) is depressed for engagement (not shown), the latch (52) extends radially outward and/or upward to engage with the spaced grooves (102) and moves toward the front wall (106) of the circumferentially spaced grooves (102), and the short edge (140). Hence, this allows the user unfasten the cap assembly (12) from the container (18) by having the short edge (140) presses against the sidewall (148) of the outer lid (20).

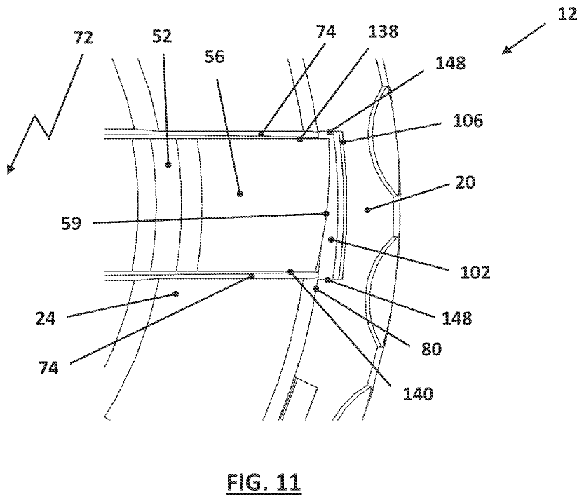

FIG. 12 shows a direct top view of the partial cross section of the child-resistant cap assembly (12). This is a very good view, with clarity of the latch (52) showing the rigid finger (56) and the shape of the curved tip (59) of the rigid finger (56). The inner lid (24) prominently displays the latch slot (74) that guides the rigid finger (56) when activated. The long edge (138) of the latch will engage the circumferentially spaced grooves (102) formed in the outer lid (20) of the cap assembly (12) when the activate button body (22) is depressed, the rigid finger(s) (56) will be extended upwards and outwards by the shaped protrusion (72) to allow the long edge (138) to unfasten the cap assembly (12) from the container (18) by a counter-clockwise rotation about the x-axis (16). Conversely, when the activate button body (22) is depressed, the short edge (140) of the rigid finger (56) will engage the circumferentially spaced grooves (102) of the outer lid (20) and will allow the short edge (140) pressing against the sidewall (148) of the circumferentially spaced grooves (102) to fasten the child-resistant cap assembly (12) when the child-resistant cap assembly (12) is rotated clockwise. The long edge (138) of the rigid finger (56) when at rest will not allow the child-resistant cap assembly (12) from being unfastened.

The outer lid (20), activate button body (22), and the inner lid (24) may be fabricated from ferrous and non-ferrous metals such as steel, tin, titanium, aluminum, etc. In lieu of ferrous and non-ferrous materials, the outer lid (20), activate button body (22), and the inner lid (24) may also be fabricated from plastics such as polyethylene, polypropylene, nylon, styrene, and even composites. All materials should be FDA approved for use.

The outer lid (20), activate button body (22), and the inner lid (24) may be fabricated by using injection molding, 3D printing, casting, and any other method that would be approved by the FDA for use in medicine container assemblies (10).

Although the present invention has been described with reference to the disclosed embodiments, numerous modifications and variations can be made, and still the result will fall within the scope of the invention. No limitation with respect to the specific embodiments disclosed herein is intended or should be inferred. Each apparatus embodiment described herein has numerous equivalents.

What is claimed is:

1. A child-resistant cap assembly for medicine bottle, comprising:
a) an outer lid, the outer lid having a top surface and a vertical wall extending downwards from the top surface creating an internal cavity therein, a first bottom surface, the first bottom surface opposing the top surface, the outer lid further having a centrally located through hole defined therein;
b) an activate button body has a circular button and having at least one rigid finger attached to the circular button by a pivotable hinge, and the rigid finger having a tip defined thereon;
c) the vertical wall of the outer lid having an inner surface, the inner surface connecting to the first bottom surface, the first bottom surface having a means to engage each rigid finger of the activate button body;
d) an inner lid has a top surface and a downward extending wall, the downward extending wall extends downwards creating an internal cavity therein, the internal cavity has a lower surface and the inner surface of the downward extending wall of the internal cavity has a means of mechanical attachment coupling to a standard container; and
e) the downward extending wall of the inner lid has an exterior surface and a bottom edge, defined on the exterior surface with a circumferentially retaining protrusions has a mechanical means of coupling to a flexible retaining ring to secure the inner lid to the outer lid.

2. The child-resistant lid container of claim 1, wherein the shaped protrusion forces the latch to be pivoted upward and/or outward by the shaped protrusion when the upper surface of the circular button is pressed in a downward position.

3. The child-resistant lid container of claim 1, wherein a desiccant basket has a fine mesh surface and has an outer edge, the outer edge of the base surface has a vertical surface defined thereon, the vertical surface extends upward and has an upper edge, a circumferential ring, the circumferential ring allows the desiccant basket to be attached to the inner lid, wherein the fine mesh surface allows any moisture to be transmitted within the sealed medicine container assembly to the desiccant package.

4. The child-resistant lid container of claim 3, wherein the circumferential ring on the desiccant backet has a mechanical snap-on defined therein, the snap-on is circumferentially defined around the upper edge of the vertical surface of the base surface and provides a locking feature for the desiccant basket.

5. The child-resistant cap assembly of claim 1, wherein the means to engage the rigid finger of the activate button body of the outer lid comprises the first bottom surface having a group of circumferentially spaced grooves defined therein, the circumferentially spaced groves having the ability to engage the rigid finger of the activate button body.

6. The child-resistant cap assembly of claim 1, wherein a circular sealing ring is defined between the inner surface of the internal cavity and the lower surface of the lower lid where the circular sealing ring is positioned at the intersection of the lower surface and the downward extending wall of the inner lid and is constantly pressed against the inside circular surface of the container that said first sealing point when assembled with the container to prevent air or moisture transmission from the outside atmosphere to entering the medicine container assembly.

7. The child-resistant packaging container of claim 1, wherein the lower surface in the internal cavity of the inner lid is pressed against the rim of the container that said second sealing point when the cap assembly is coupling with the container to prevent elements from the outside to entering the medicine container assembly.

8. The child-resistant packaging container of claim 1, wherein the inner lid is coupled with the container when the cap assembly is in a closed and secure position thereby, the upper lid can rotate radially around the x-axis functioning as a child-resistant feature, and the flexible retaining ring snaps on the circumferentially spaced retaining protrusions to prevent the separation of the cap assembly and medicine container.

9. The child-resistant cap assembly of claim 1, wherein the top surface of the outer lid may have operation instructions or identification can be placed thereon.

10. The child-resistant cap assembly of claim 9, wherein the markings have been engraved, molded, or formed thereon.

11. A child-resistant cap assembly comprising:
a) a packaging container is connected to a child-resistant cap assembly;
b) the child-resistant cap assembly has an outer lid, an activate button body and an inner lid;
c) the outer lid has a vertical wall, the vertical wall extending downward and creating an internal cavity, the vertical wall further has a first bottom edge and an inner surface, the first bottom edge has a flexible retaining ring extending inwards defined thereon, the vertical wall further having an outer surface, the outer surface allowing a grip surface to be placed thereon, the internal cavity of the outer lid further having a first bottom surface, the first bottom surface having circumferentially spaced grooves defined therein, each groove of the circumferentially spaced grooves has opposing walls, the circumferentially spaced grooves being placed adjacent to the vertical wall of the inner lid;
d) the outer lid has a centrally located thru hole, allowing the activate button body to move linearly along the x-axis, the centrally located through hole and the activate button body have a gap defined therein to allow effortless movement of the activate button body;
e) the activate button body has at least one latch extending outwardly from the x-axis, the latch extending towards a vertical wall of an inner lid, the inner lid having a top surface, the top surface of the inner lid being adjacent to the downward extending wall and having a shaped protrusion formed or an outward ramp therein, the shaped protrusion is positionally located within a latch slot positioned on the top surface of the inner lid, allowing a latch to be positioned therein; and
f) the inner lid further has a female fastening located on the inner surface of the inner lid that interfaces with male fastening on the container.

12. The child-resistant packaging container of claim 11, wherein applying pressure to an upper surface of the activate button body causes the circular button to move linearly along the x-axis, thereby raising a tip of the latch to move outwardly and radially by the shaped protrusion protruding into the circumferentially spaced grooves of the outer lid and engaging at least one of the circumferentially spaced grooves in the outer lid thereby, the latch pressing against the opposing set of side walls in the circumferentially spaced grooves allowing the child-resistant cap to be opened.

13. The child-resistant packaging container of claim 11, wherein the inner lid has at least one latch slot, the latch slot having a slot bottom wall and opposing side walls defining the latch slot, the latch slot bottom wall curves upward where the latch slides radially outward between the opposing side walls of the latch slot and into an opposing side wall of the circumferentially spaced grooves of the outer lid.

14. The child-resistant packaging container of claim 11, wherein a desiccant basket attaches to a lower surface of the inner lid, the inner lid has at least a snap-on finger defined thereon that engages the desiccant basket, the desiccant basket has a circumferential ring, and a snap-on groove where the snap-on groove can be attached to the inner lid.

15. The child-resistant packaging container of claim 14, wherein the desiccant element is contained separately in the desiccant basket which is separated from the product in the container.

16. The child-resistant packaging container of claim 11, wherein the inner cap assembly has the outer lid, activate button, and inner lid rotating radially about the x-axis when engaged together.

17. The child-resistant packaging container of claims 1 and 11, wherein the outer lid, the activate button body, the inner lid, and desiccant basket are made from the group of polymers, comprising thermosets, thermoplastics, composites, and recycled materials.

18. A child-resistant packaging container comprising:
a) an outer lid, an activate button body and an inner lid;
b) the outer lid has a centrally located through hole defined therein and a downward extending wall defining a cavity therein;
c) the activate button body has a circular button that aligns and fits into the centrally located through hole defining a gap therebetween;
d) the inner lid has an upper surface and a downward extending wall defining a cavity therein, the upper surface has at least one latch slot defined therein, the latch slot has opposing walls and a latch bottom wall, the latch bottom wall has a shaped protrusion or an outward ramp defined therein;
e) the activate button body has at least one latch, the latch has a connecting flexible hinge that flexibly attaches the rigid finger to the circular button, the rigid finger is positioned in the latch slot, the latch slot being positioned on the inner lid; and
f) the latch is flexibly connected to a circular button and has a tip that extends outwardly into the outer lid, the outer lid having circumferentially spaced grooves defined in a first bottom surface of the outer lid when the circular button is depressed.

19. The child-resistant packaging container of claim 18, wherein;
a) the outer lid has a vertical wall, the vertical wall extends downward and has a first bottom edge, the first bottom edge has a flexible retaining ring defined thereon, the inner lid has a wall extending downwards creating a cavity therein, the wall of the inner lid has an exterior surface, biased towards a bottom edge of the exterior surface of the wall of the inner lid are circumferentially spaced retaining protrusions defined thereon, the circumferentially spaced retaining protrusions are adapted to fit into the underside of the outer lid using the flexible retaining ring, and is retained by the flexible retaining ring on the outer lid and the flexible retaining protrusions positioned on the exterior surface of the inner lid; and
b) the circumferentially spaced retaining protrusions and an inner surface of the vertical wall have a clearance gap defined therebetween allowing for free rotation about the x-axis.

20. The child-resistant packaging container of claim 18, wherein the first bottom edge of the vertical wall of the outer lid has a leading angle that assists in aligning and capturing the inner lid when the inner lid is installed.

21. The child-resistant packaging container of claim 18, wherein the tip of the rigid finger has a design feature with a longer edge that is partially extended into the circumferentially spaced grooves, and a short edge that is slightly recessed below the exterior surface of the inner lid, wherein the outer lid can be rotated counterclockwise freely about the X axis, thereby retracting backward into the latch slot that said a child-safety feature.

22. The child-resistant packaging container of claim 18, wherein the curved tip of the rigid finger has a longer edge that is partially extended into the circumferentially spaced grooves, and a short edge that is slightly recessed below the exterior surface of the inner lid, wherein the outer lid can be rotated clockwise about the X axis to close and tighten the cap assembly to the container.

23. The child-resistant packaging container of claim 18, wherein the curved tip of the rigid finger has a longer edge and a short edge extended into the circumferentially spaced grooves of the outer lid when pressed on the activate button.
